(19) United States
(12) Patent Application Publication
(10) Pub. No.: US 2026/0274998 A1
(43) Pub. Date: Sep. 17, 2026

(54) LOW VISCOSITY CM-MFC

(71) Applicant: SUZANO S.A., SALVADOR (BR)

(72) Inventors: Bruna Papa SPADAFORA, Americana (BR); Estevão Frigini MAI, Vila Velha (BR); Heloísa Ogushi Romeiro RAMIRES, Aracruz (BR)

(73) Assignee: SUZANO S.A., SALVADOR, BA (BR)

(21) Appl. No.: 19/167,569

(22) PCT Filed: Mar. 22, 2024
(86) PCT No.: PCT/BR2024/050107

§ 371 Date: Sep. 22, 2025

Related U.S. Application Data
(60) Provisional application No. 63/453,874, filed on Mar. 22, 2023.

(51) Int. Cl. C08B 11/12; C08B 1/02; C08B 11/20

(52) U.S. Cl. CPC C08B 11/12; C08B 1/02; C08B 11/20

(57) ABSTRACT

The present invention relates to a low viscosity CM-MFC comprising a substitution degree of 0.2-0.29, preferably with a viscosity between 6700-9900 cP with a spindle R4 at 100 rpm at 1% w/w and a viscosity between 65-85 cP with a spindle R4 at 10 rpm at 0.8% w/w and a method for producing a low viscosity CM-MFC, comprising:
defibrating the resulting CMC with a rotating disc and a stationary rotor with a water dispersion of 4-10% w/w to obtain a CM-MFC at an extent that the CM-MFC fiber average diameter is between 0.8 μm to 8 μm.

### FIELD OF THE INVENTION

The present invention relates to a low viscosity CM-MFC comprising a degree of substitution of 0.2-0.29, preferably with a viscosity between 6700-9900 cP with a spindle R4 at 100 rpm at 6% w/w and a viscosity between 65-85 cP with a spindle R4 at 10 rpm at 0.8% w/w and a method for producing a low viscosity CM-MFC, comprising:
defibrating CMC, DS between 0.20-0.29 with a rotating disc and a stationary rotor with a water dispersion of 4-10% w/w to obtain a CM-MFC at an extent that the CM-MFC fiber average diameter is between 0.8 μm to 8 μm.

### BACKGROUND

Carboxymethylated microfibrillated cellulose is traditionally stable, homogenous suspensions, characterized as useful in end use products including foods, cosmetics, pharmaceuticals, paints, and drilling muds.

The carboxymethylated microfibrillated cellulose (CM-MFC) may be used, for example, in cosmetic applications as a thickener, an agent imparting shape retention ability, an emulsion stabilizer, or a dispersion stabilizer in the field of cosmetic products such as face powders, foundations, scrub agents for face washing, packs, cleansing foams, cleansing creams, hair mousses, shampoos, soap, lotions, hair colors, hair bleaches, mascara, eyeliners, manicures, and antiperspirants, without any limitation thereto. Sometimes a rolling effect may occur wherein the applied skin care composition detaches from the skin and forms undesirable clumps.

In the area of household products, the rheological properties of the present carboxymethylated microfibrillated cellulose (CM-MFC), and their ability to stabilize emulsions, dispersions, and foams, may provide utility in areas such as detergents, shampoos, cleaners, and air fresheners. Specific examples include, without limitation, laundry products (including detergents, pre-spotting cleaners, and fabric treatment compositions, such as softeners); rug and upholstery shampoos; toilet bowl cleaners (particularly those dispensed in liquid or gel form); air fresheners; and general-purpose cleaning agents, including liquids, gels, pastes, and foams used in cleaning and/or disinfecting household surfaces.

In the area of paper manufacture and treatment, the carboxymethylated microfibrillated cellulose (CM-MFC) of the present invention may have utility in emulsion modification and/or stabilization; sizing; retention; clarification; absorbance; drainage; formation (such as by functioning as flocculation aids); deposit or scale control (by inhibiting the formation and/or growth of inorganic deposits); water treatment; dewatering; film and membrane formation; polyelectrolyte cross-linking; removal of detrimental organic and/or inorganic materials; in paper coatings; and in improving properties such as stiffness, wet strength, absorbency, softness, toughness, tear resistance, and fold resistance.

In the context of paper manufacture, scale control refers to the prevention of calcium carbonate and calcium oxalate deposits forming during the pulping process. Scale control can be achieved by dispersion of salt crystals in the medium to prevent growth and deposition, inhibition of nucleation, or modification of the crystal growth mechanism to prevent the formation of crystal forms that will lead to deposits. The use of carboxymethylated microfibrillated cellulose (CM-MFC) having micron and smaller particle size, stabilized with appropriate functional groups, may serve to control scale deposit because such microcarriers inhibit the crystal growth which leads to deposition. Moreover, cellulosic materials would be easier to recover from the pulping process due to their organic nature. Preferred functional groups would include phosphate/phosphonate groups, carboxylate groups, and sulfate/sulfonate groups. Alternative functional groups and appropriate use levels may be readily determined by those of ordinary skill in the art, based on the particular environment of use.

The derivatized microfibrillar cellulose may also be used in a papermaking machine to increase the rate of drainage and/or dewatering during paper manufacture; to retain organic and/or inorganic dispersed particles (such as pulp fines, fillers, sizing agents, pigments, and/or clays); to retain detrimental organic and inorganic particulate materials; to improve the uniformity of formation of a sheet of paper; and to improve the strength of a sheet of paper. With particular regard to drainage, drainage aids are additives that increase the rate at which water is removed from a paper slurry on a paper machine. These additives increase machine capacity, and hence profitability, by allowing faster sheet formation. Anionically charged microfibrillar cellulosic derivatives are capable of greatly increasing drainage, either alone or in combination with other charged polymers.

The derivatized microfibrillar cellulose of the present invention may also be used in coated papers, where cellulose derivatives may be used to control the rheology of the color coating and to provide water retention, thereby controlling the amount of liquid that permeates into the base sheet.

In coating compositions, such as paints and inks, the derivatized microfibrillar polysaccharides can provide rheology modification, improving properties such as spatter, leveling, sag resistance, flooding, and floating, and may have particular utility in gel paints. They may also improve pigment dispersion and/or stabilization, and function as charge control or flow control agents, including in inks, such as ink jet inks.

There is a need for a carboxymethylated microfibrillated cellulose (CM-MFC) that has a relatively low degree of substitution with low viscosities that provides, for example, good spreadability and low dripping or running down.

For instance, EP 3126570 B1 discloses a method for producing carboxymethylated microfibrillated cellulose (CM-MFC), wherein the cellulose-based fiber material, in which the internal bonds in the cellulose fibers have been weakened by the preliminary modification of the cellulose, is subjected to disintegration treatment at a consistency 10-50% through repeated successive impacts from opposite directions. CM-MFC has a crystallinity of 0.1-0.35 and degree of substitution of 0.1-0.2; zero shear viscosity of 1,000-50,000 Pa·s and a yield stress of 1 to 50 Pa, when measured at a consistency of 0.5 percent, having a mean diameter of 100-1000 micrometers, with an anionic charge of 1.00-1.55 mmol/g (0.33-0.51). This document describes a method of obtaining CM-MFC at 10-50% high consistency which the fiber was subject to carboxymethylation having a degree of substitution between 0.12-0.20 and, at 0.8% consistency and 10 rpm, has a viscosity >5000 cP. The present CM-MFC at 0.8% consistency at 10 rpm has a much lower viscosity between 65-85 cP.

U.S. Pat. No. 9,909,256 BB discloses a carboxymethylated microfibrillated cellulose (CM-MFC) having lengths exceeding 1 μm, while the diameter normally remains less than 200 nm. It reveals a method for fibrillation of cellulose in a homogenizer with a consistency of 1.5 to 3.5% and homogenized at a pressure of 300 to 650 bar; in which it is fibrillated to a degree with Brookfield viscosity greater than 35,000 mPa·s (2 passes at 1% consistency 30,000 mPa·s, 4 passes 1% consistency 39,000 mPa·s) at a measurement consistency of 0.8 per percent and a rotation speed of 10 rpm. Furthermore, CM-MFC has a substitution of 0.6 to 1.2 mmol/g, corresponding to about 0.2-0.4. The CM-MFC of the present invention is not obtained by homogenization, and has a larger dimension than revealed, wherein the refining consistency is 6% and we use rotor/stator mechanical refining resulting in a CM-MFC at 0.8% consistency at 10 rpm a viscosity between 65-85 cP, in contrast to a viscosity at 0.8% consistency at 10 rpm of 10000 cP of U.S. Pat. No. 9,909,256 BB.

EP 3951050 A1 discloses a carboxymethylated microfibrillated cellulose (CM-MFC) with a degree of substitution of 0.01-0.5 and with a degree of crystallization of type I cellulose of 50 percent or greater and a water-based medium. It reveals a CM-MFC with a mean diameter of 10.0 to 150.0 μm and a viscosity (6 rpm, 25° C.) of 1,000-30,000 mPa·s at 1 percent (w/v) and substitution of 0.01-0.5 (0.1-2.5 mmol/g). Carboxymethylation of cellulose is carried out by monochloroacetic acid in alcoholic solvent. The CM-MFC of the present invention has a viscosity ranging from 111.9-121.9 cP at 1% solids at 60 rpm, 25° C. and viscosity ranging from 65-85 cP at 0.8% solids at 10 rpm, 25° C., in contrast to viscosities up to 4000 cPs of EP 3951050 A1.

EP 2782937 B1 discloses method for manufacturing water-insoluble carboxymethylated microfibrillated cellulose (CM-MFC) with a degree of substitution between 0.05 and 0.35 carboxymethyl groups per anhydroglucose unit, wherein the carboxymethylation reaction is carried out at least partially with a consistency of 50% or more. Refining is disk or conical to a consistency between 1-30% w/v and CM-CMF has a substitution of 0.1-0.25 and loading of 0.3-0.77 mmol/g, a zero shear viscosity from 5,000 to 100,000 Pa·s measured at a 0.5 percent concentration in water. The cellulose fiber is treated, to form a slightly carboxymethylated cellulose with such a degree of substitution that it is not soluble in water, with an alkalizing agent (sodium hydroxide) and an anionic agent, such as monochloroacetic acid, preferably sodium monochloroacetate (SMCA). It reveals that the wood can be from softwood trees, such as spruce, pine, spruce, larch, spruce or hemlock, or from hardwood trees, such as birch, poplar, poplar, alder, eucalyptus or akhasia, in a chemical pulp of the sulfate wood pulp type with fibers from 15 to 25 μm and the length exceeds 500 μm. The CM-MFC of the present invention has a viscosity ranging from 111.9-121.9 cP at 1% solids at 60 rpm, 25° C. and viscosity ranging from 65-85 cP at 0.8% solids at 10 rpm, 25° C., in contrast to viscosities up to 4000 cPs of EP 3951050 A1.

Therein, the present invention provides a carboxymethylated microfibrillated cellulose (CM-MFC) that has a relatively low degree of substitution with low viscosities.

### SUMMARY OF THE INVENTION

A first objective of the present invention is a low viscosity CM-MFC comprising a substitution degree of 0.2-0.29, preferably with a viscosity between 6700-9900 cP with a spindle R4 at 100 rpm at 6% w/w and a viscosity between 65-85 cP with a spindle R4 at 10 rpm at 0.8% w/w.

Another objective of the present invention is to provide a method for producing a low viscosity CM-MFC, comprising:
defibrating the resulting CMC with a rotating disc and a stationary rotor with a water dispersion of 4-10% w/w to obtain a CM-MFC at an extent that the CM-MFC fiber average diameter is between 0.8 μm to 8 μm.

Preferably, the CM-MFC obtained has a viscosity between 6700-9900 cP with a spindle R4 at 100 rpm at 6% w/w and a degree of crystallinity of 38-49%.

### FIGURES

FIG. 1 is a MEV image of a BEKP CMC used in the present invention with a magnification of 500×.

FIG. 2 is a MEV image of a BEKP CMC used in the present invention with a magnification of 1,000×.

FIG. 3 is a MEV image of a BEKP CMC used in the present invention with a magnification of 5,000×.

FIG. 4 is a MEV image of the CM-MFC of the present invention with a magnification of 15,000×.

FIG. 5 is a MEV image of the CM-MFC of the present invention with a magnification of 15,000×.

FIG. 6 is a MEV image of the CM-MFC of the present invention with a magnification of 40,000×.

FIG. 7 is a MEV image of the CM-MFC of the present invention with a magnification of 40,000×.

FIG. 8 is an image of the CM-MFC at 6% w/w in water of the present invention.

FIG. 9 is a graphic depiction of the evolution of the viscosity with the Net Specific Energy (kWh/t) input during refining of the CM-MFC of the present invention.

FIG. 10 is a graphic depiction of the evolution of the viscosity with the Total Specific Energy (kWh/t) input during refining of the CM-MFC of the present invention.

FIG. 11 is a graphic depiction of the evolution of the % of Fines x Viscosity during refining of the CM-MFC of the present invention.

FIG. 12 is a graphic representation of the compared viscosity behavior of the originating CMC and the obtained CM-MFC of the present invention.

### DETAILED DESCRIPTION OF THE INVENTION

The present invention is directed to a low viscosity CM-MFC.

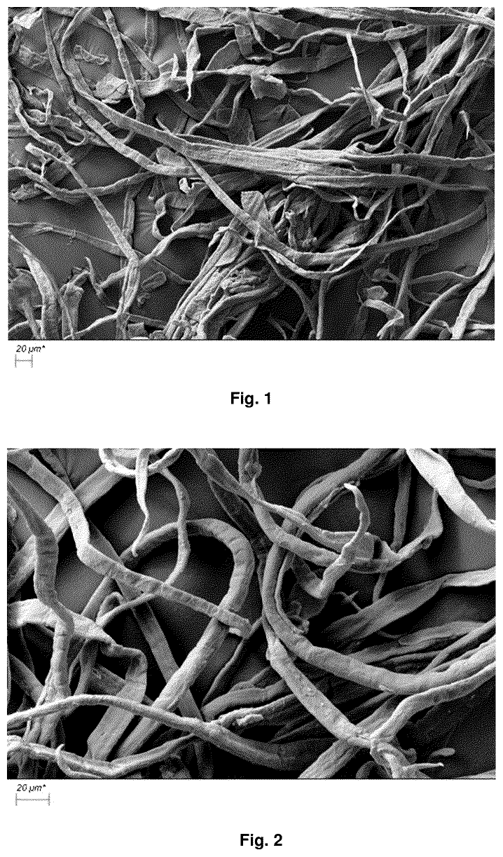

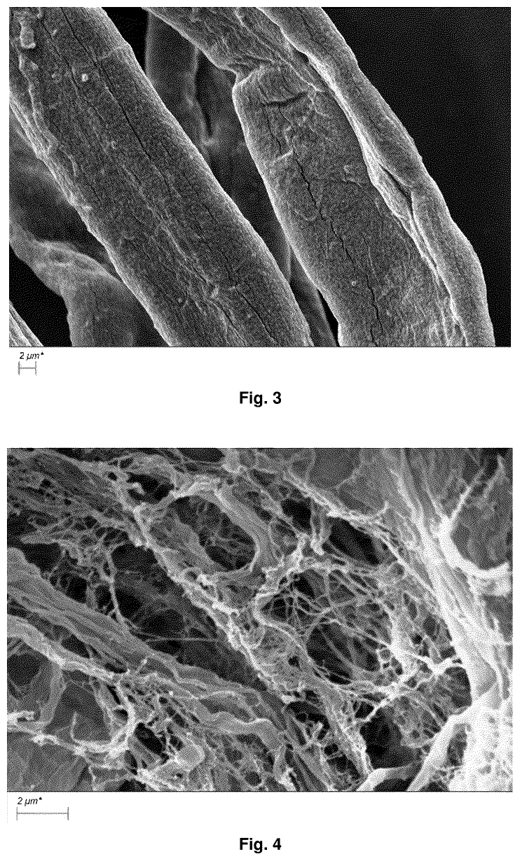

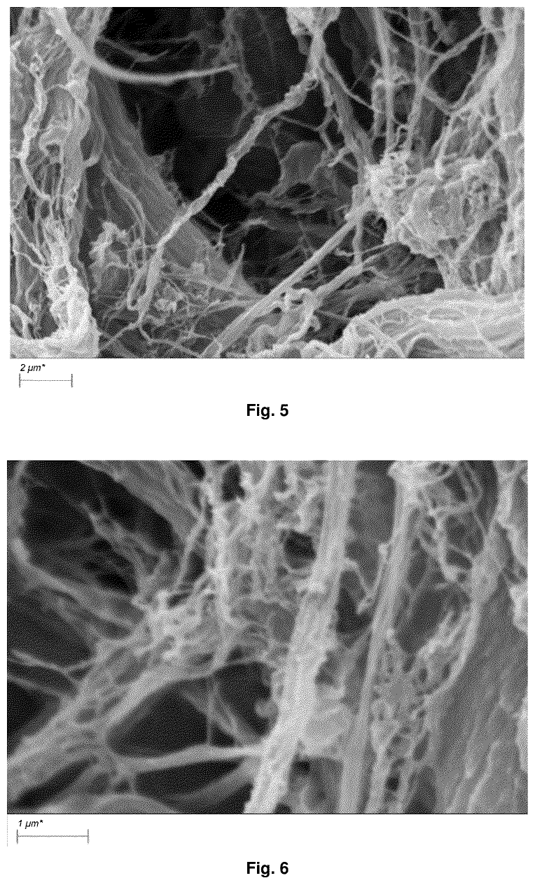

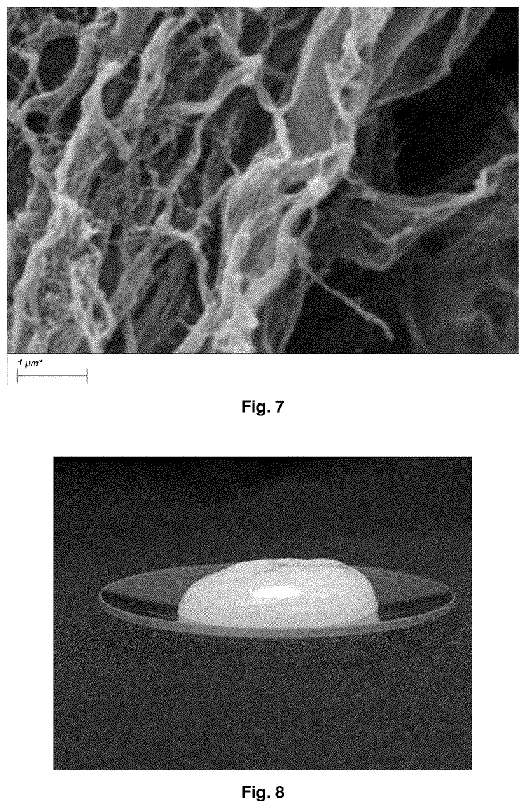

MFC refers to microfibrillated cellulose having cellulose microfibrils or microfibril bundles separated from cellulose-based fiber raw material. The term “fibrillation” generally refers to disintegrating fiber material mechanically by work applied to the cellulose fiber, where cellulose fibrils are detached from the fibers or fiber fragments. Often used interchangeably, the names for microfibrillated cellulose (MFC) and nanofibrillar cellulose (NFC) are distinct products with distinct characteristics. Fibrillated cellulose may be classified as NFC and MFC. NFC is a nanofibrillated cellulose with denominated fibrils having lengths typically up to 100 micrometers and diameters ranging from 3-100 nm. MFC is a microfibrillated cellulose with fibrils usually having undefined lengths, but usually from cellulose fibers having 1-4 mm, as illustrated at FIGS. 1, 2 and 3, with fibrillated diameters larger than 100 nanometers. Methods for measuring the diameter and length of NFC and MFC are known to the expert, and Norm CSA 25100 for Cellulose Nanomaterials on Test methods for characterization is preferred if necessary. The dimensions and size distribution of the fibrils depend on the refining method and efficiency. In water dispersion, MFC typically appears as either light or almost colourless gel-like material. Preferably, the MFC of the present invention is a derivatized MFC, more preferably a carboxymethylated MFC (CM-MFC). FIGS. 4-7 illustrate the CM-MFC of the present invention.

Derivatization of MFC provides the CM-MFC with groups with electrostatic functionality, and the derivatized microfibrillar cellulose CM-MFC of the present invention may have a degree of substitution is between 0.2 and 0.29, with an ionic charge between 119-136 meq/100 g resulting in a viscosity between 6700-9900 cP with a spindle R4 at 100 rpm at 6% w/w; a viscosity between 110-130 cP at 60 rpm at 1% w/w and a viscosity between 65-85 cP at 10 rpm at 0.8% w/w. FIG. 8 is an image of the CM-MFC of the present invention in water at 6% w/w.

The carboxymethylated modified fiber material that is used as starting material can be based on any plant material that contains cellulose and was subjected to a derivatization process forming a CMC. The originating plant material may be wood. The wood can be from softwood trees such as spruce, pine, fir, larch, douglas-fir or hemlock, or from hardwood trees such as birch, aspen, poplar, alder, eucalyptus or acasia, or from a mixture of softwood and hardwood.

In an aspect of the present invention, the pulp is prepared from a pulp such as a mechanical pulp, a thermomechanical pulp, a chemi-thermomechanical pulp, a chemical pulp (e.g., Kraft, Soda or Sulfite), a bleached pulp, a recycled pulp (optionally combining cleaning and de-inking steps), a steam exploded fiber pulp or a biologically (enzymatically) treated pulp. Preferably, the CMC is obtained from cellulose fibers obtained by kraft pulping or pulping via kraft process.

Examples of wood pulps used to obtain the CMC include mechanical pulp, thermomechanical pulp, chemi-thermomechanical pulp and chemical pulp. For example, Bleached Eucalyptus Kraft Pulp (BEKP), Northern Bleached Softwood Kraft pulp (NSBK), Bleached Softwood Kraft pulp, Bleached Hardwood pulp, unbleached softwood and hardwood Kraft pulps, Sulfite Bleached pulp, Bleached Chemi-Thermo Mechanical Pulp (“BCTMP”), are used to obtain an MFC. Each type of pulp provides slightly different MFC's, having different properties and dimensions. Preferably, the carboxymethylated modified fiber material CMC is from hardwood pulp, preferably CMC pulp from Bleached Eucalyptus Kraft Pulp (BEKP) is used in the present invention

Cellulose raw material comprises fibers in bundles of fibrils. When mechanically disintegrated, the cellulose fibrils are isolated from the cellulose bundles. In this sense, MFC (microfibrillated cellulose) is to be understood to comprise partly or totally fibrillated cellulose or lignocellulose fibers, which may be achieved by a variety of processes known in the art. As cellulose found in nature has several hierarchical levels of organization and orientation, cellulose fibers comprise a layered secondary wall structure within which macrofibrils are arranged. Macrofibrils comprise multiple microfibrils which further comprise cellulose molecules arranged in crystalline and amorphous regions. Preferably, the cellulose used in the present invention has a crystallinity degree between 52%-62%.

The fiber material dispersion that is subjected to fibrillation is a mixture of fiber material and water, preferably BEKP CMC and water, forming a CMC slurry. The CMC slurry may refer generally to whole fibers, parts (fragments) separated from them, fibril bundles, or fibrils mixed with water, and typically the fiber material dispersion is a mixture of such elements, in which the ratios between the components are dependent on the degree of processing. Preferably, the fibers are mixed with water and more preferably, the fibers are CMC from BEKP pulp, refined between 4-10% w/w. As it can be noted, CMC allows using higher solids content for refining when compared to traditional MFC, which demands higher amounts of solvent, such as water.

In one aspect of the present invention the cellulose fibers are first derivatized and then refined. Preferably, the cellulose is carboxymethylated to a degree of substitution between 0.2 and 0.29 to provide a carboxymethylated cellulose (CMC) and then are refined to a median diameter (d50) of less than 8 μm, preferably refined to a diameter ranging from about 0.8 μm to 8 μm. In one aspect of the present invention, the obtained CMC is refined with a Gross specific energy between 450-580 kWh/t.

In terms of general properties, the CM-CMC of the present invention have particular rheological attributes that include at least a desired low viscosity with a reasonable degree of substitution. Preferably, the CM-MFC of the present invention, comprises a shear is 35-44 cP @50 rpm; 0.85% w/w, having a viscosity between 6700-9900 cP with a spindle R4 at 100 rpm at 6% w/w; a viscosity between 110-130 cP at 60 rpm at 1% w/w and a viscosity between 65-85 cP at 10 rpm at 0.8% w/w. The CM-MFC of the present invention also has a transmittance ranging from 45%-59% with a wavelength of 660 nm and a conductivity of 2.53-2.60 mS/cm @ 1% w/w.

Microfibrillation is a process in which microfibrils of cellulose are liberated or partially liberated as individual species or as small aggregates as compared to the fibers of the pre-microfibrillated pulp. Typical cellulose fibers include larger aggregates of hundreds or thousands of individual cellulose fibrils.

Typically, the MFC used in the present invention is a fibrillated cellulose comprising cellulose fibrils having at diameter of less than 0.7 micrometers. As the diameter of cellulose fibrils depends on the source of the wood and the method of fibrillation employed, MFC's from different wood sources and previous treatment process such as pulping may provide MFC's with different characteristics. Examples of fibrillation are single or multiple pass refining, with high shear disintegration or liberation of fibrils, carried out with a refiner, grinder, homogenizer, colloider, friction grinder, ultrasound sonicator, single- or twin-screw extruder, fluidizer such as microfluidizer, macrofluidizer or another fluidizer-type homogenizer. Depending on the method, the product might also contain fines, or nanocrystalline cellulose or e.g., other chemicals present in wood fibers or in papermaking process. Preferably, mechanical fibrillation is used to obtain the CM-MFC used in the present invention. Preferably, a mechanical fibrillation method may be used, such disclosed those at PCT WO21226693 A1; subjecting the CMC fiber in a slurry to multiple mechanical impacts with non-cutting bars disposed in a ring formation of projections is the preferred configuration. Two rings concentrically arranged facing each other having several bars as projections in high rotation transmit the kinetic energy to the fibers producing the CM-MFC, such as Atrex equipment. Alternative refining may be employed wherein any type of refiner is used, i.e., fibrillation with low, medium or high shear with a rotating disc and a stator to obtain the MFC used in the present invention. Preferably, the CMC used in the present invention is obtained from refining methods that operate at net energy inputs between 300-450 kWh/t, to obtain a CM-MFC with a diameter between 200-700 nanometers.

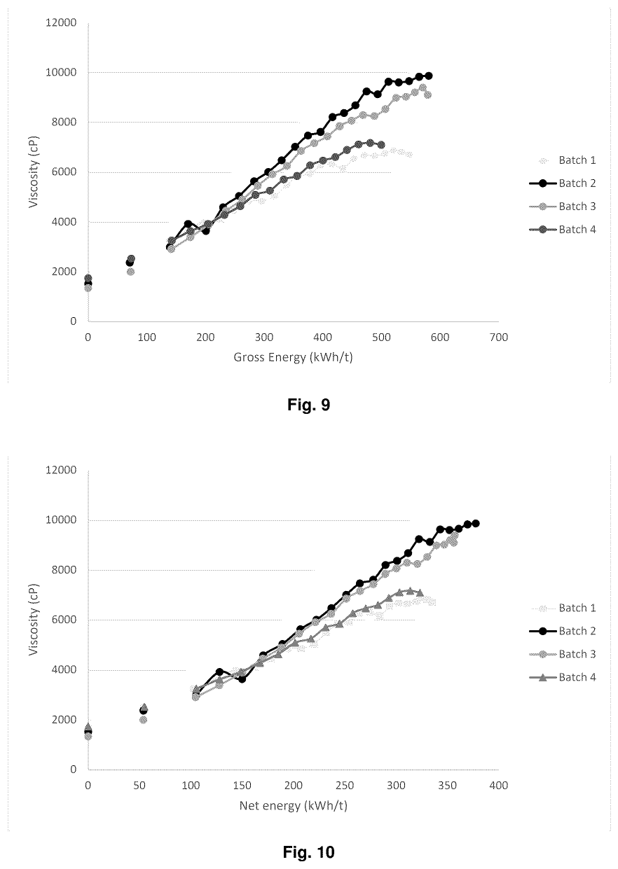

FIG. 9 is a graphic depiction of the evolution of the viscosity with the Gross Specific Energy (kWh/t) input and FIG. 10 with the Net Specific Energy (kWh/t) input during refining of the CM-MFC of the present invention having substitution degrees of 0.20 and 0.29, which illustrates the increase of viscosity with energy input.

Microfibrillation may be accomplished by applying energy to a pulp under conditions sufficient to produce microfibrillar polysaccharides. The pulp may be a carboxymethylated cellulose, CMC. More specifically, refining may be carried out in one or more stages. For example, a cellulose pulp may be refined to a predetermined diameter, after which the material comprising cellulose goes through another refining until the desired level of microfibrillation has been obtained. In one embodiment, the refining may be accomplished in one step, obtaining the CM-MFC used in the present invention. In a preferred embodiment the CMC is passed through a refiner under conditions sufficient to produce a CM-MFC; those conditions may include a grinding energy of at least 300 kWh/t, and passing the CM-MFC through the refiner may be performed one or more times, re-feeding the same refiner of using sequential refiners.

The carboxymethylated cellulose pulp (CM-MFC) may be wet refined in the presence of water, forming a cellulose pulp suspension. Typically, the CM-MFC suspension is refined at a concentration, or solids content, between 4-10 wt. %, providing, accordingly, a CM-MFC at a concentration, or solids content between 4-10 wt. %.

In one aspect, the refining method is mechanical refining having a rotating disc and a stator. In a preferred embodiment, the carboxymethylcellulose is suspended in water and the resulting suspension is refined to produce microfibrillated carboxymethylcellulose or CM-MFC. In one aspect, the present invention is a method for producing a low viscosity CM-MFC, comprising
defibrating the resulting CMC with a rotating disc and a stationary rotor with a water dispersion of 4-10% w/w to obtain a CM-MFC at an extent that the CM-MFC fiber average diameter is between 0.8 μm to 8 μm.

The method of the present invention should yield a CM-MFC that is dispersed in water. Water is the preferred liquid for the suspension that is formed. Enzymes may be employed before, during or after fibrillation.

Preferably, the CM-MFC obtained has a viscosity between 6700-9900 cP with a spindle R4 at 100 rpm at 6% w/w and a degree of crystallinity of 38-49%.

### Example

### Refining the CMC

A CMC BEKP with a substitution degree of 0.20-0.29 is introduced at a consistency of 4-5% solids into a disc refiner DD 6700 having a disc with a bar width of 1.5 mm, channel width of 2.5 mm bar height of 4.00 mm and an angle of 15°. Fibrillation is an operating temperature of 60° C., and an edge speed of 200 m/s or 895 rpm and the fiber is processed until there is no increase in apparent viscosity, usually under 15-180 minutes.

Table 1 has the carboxylic acid content of the originating CMC and the CM-MFC obtained after fibrillation of the originating.

TABLE 1

| Sample | Carboxylic acid (mEQ/100 g) |
|---|---|
| CMC-1 | 96.72 |
| CMC-2 | 92.37 |
| CMC-3 | 96.18 |
| CM-MFC 1 | 126.90 |
| CM-MFC 2 | 127.12 |
| CM-MFC 3 | 119.58 |
| CM-MFC 4 | 135.26 |

The samples crystallinity was performed having samples in suspension in distilled water, each containing about 0.2 g of the sample. The suspensions were then transferred to Petri dishes and dried at room temperature. After drying, the films were detached and X-ray diffraction analysis were performed.

The diffractograms of the samples were recorded using an X-ray diffractometer, Panalytical brand, Empyrean model, belonging to the Laboratory of Materials for Construction Products of the Housing and Buildings area of IPT. The wavelength of CuKα radiation (>=1.54 Å) was used, with a Bragg angle sweep of 2θ from 5° to 30° and a step of 0.01°. The voltage and current used were 45 kV and 40 mA. The crystallinity index of the samples sent was calculated according to the expression proposed by SEGAL et al. (1959, apud TSOUKO, 2015, p. 14844): CrI=(1002-Iam/I002)·100 where CrI is the crystallinity index, I002 is the maximum intensity referring to the diffraction close to the angle 2θ=23° (diffraction plane 002) and Iam is the intensity referring to the amorphous region close to the angle 2θ=18°−19°. The results are shown in Table 2.

TABLE 2

| Sample | Crystallinity degree (%) |
|---|---|
| CMC-1 | 53.2 |
| CMC-2 | 57.4 |
| CMC-3 | 61.2 |
| CM-MFC 1 | 40.0 |
| CM-MFC 2 | 38.0 |
| CM-MFC 3 | 44.8 |
| CM-MFC 4 | 49.2 |

The batches were also measured for viscosity. The results are shown in Table 3:

TABLE 3

| | Condition 1 | Condition 2 |
|---|---|---|
| | Viscosity (1%, 60 rpm, 25° | Viscosity (0.8%, 10 rpm, 25° |
| | C.) | C.) |
| Batch 1 | 127.4 cP | 76.9 cP |
| Batch 4 | 111.9 cP | 69.0 cP |
| Batch 2 | 120.8 cP | 71.6 cP |
| Batch 3 | 121.9 cP | 82.5 cP |

Other parameters were also measure as per Tables 4 and 5:

TABLE 4

| | | Net | Gross | | Viscosity cP |
|---|---|---|---|---|---|
| | | specific | specific | | (Spindle R4 + |
| | | energy | energy | Fines | 100 RPM) at |
| Batches | DS | (kWh/t) | (kWh/t) | (%) | 6% consistency |
| 1 | 0.28-0.29 | 335 | 457 | 86.9 | 6731 |
| 4 | | 323 | 499 | 78.9 | 7091 |
| 2 | 0.20-0.22 | 377 | 580 | 82.4 | 9866 |
| 3 | | 357 | 579 | 80 | 9393 |

TABLE 5

| | | | | Transmittance | |
|---|---|---|---|---|---|
| | | | | at 0.1% | Conduc- |
| | | Carboxylic | Degree of | consistency | tivity at |
| | | acids | crystal- | and 660 nm | 1% consis- |
| Batches | DS | (meq/100 g) | linity | wavelength | tency |
| 1 | 0.28-0.29 | 126.90 | 40.0% | 45.64% | 2.60 mS/cm |
| 4 | | 127.12 | 38.0% | 45.54% | 2.58 mS/cm |
| 2 | 0.20-0.22 | 119.58 | 44.8% | 58.58% | 2.53 mS/cm |
| 3 | | 135.26 | 49.2% | 56.82% | 2.56 mS/cm |

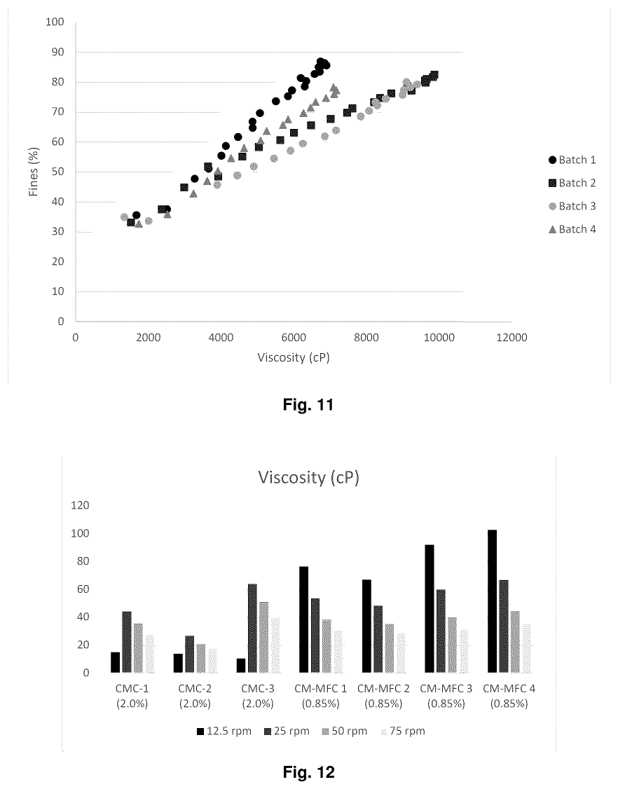

FIG. 11 is a graphic depiction of the evolution of the % of Fines x Viscosity during refining of the CM-MFC of the present invention.

Table 6 shows the results for viscosity comparing the CMC initially used and the obtained CM-MFC.

TABLE 6

| | Viscosity (cP) | | | |
|---|---|---|---|---|
| Sample | 12.5 rpm | 25 rpm | 50 rpm | 75 rpm |
| CMC-1 (2.0%) | 14.88 | 44.10 | 35.70 | 28.50 |
| CMC-2 (2.0%) | 13.83 | 26.59 | 20.82 | 17.69 |
| CMC-3 (2.0%) | 10.35 | 63.81 | 51.15 | 40.41 |
| CM-MFC 1 (0.85%) | 76.31 | 53.53 | 38.21 | 31.72 |
| CM-MFC 2 (0.85%) | 67.01 | 48.18 | 35.16 | 29.55 |
| CM-MFC 3 (0.85%) | 91.94 | 59.72 | 39.93 | 31.95 |
| CM-MFC 4 (0.85%) | 102.75 | 66.63 | 44.56 | 35.64 |

FIG. 12 is a graphic illustration of such results. As it can be noted, the CM-MFC is provided with a pseudo-plastic behavior, which is of interest in application that demand good mixing and spreadability, as with low viscosities under stress, such as in wall paintings, while at the same time stays in place after application, denoted by the high viscosity when not stressed. Also, when used in cosmetic applications formation of rollings is usually decreased due to the good spreadability.

1. A low viscosity CM-MFC comprising a substitution degree of 0.2-0.29.

2. The CM-MFC from claim 1, wherein the CM-MFC comprises a viscosity between 6700-9900 cP with a spindle R4 at 100 rpm at 6% w/w.

3. The CM-MFC from claim 1, wherein the CM-MFC comprises a viscosity between 110-130 cP at 60 rpm at 1% w/w.

4. The CM-MFC from claim 1, wherein the CM-MFC comprises a viscosity between 65-85 cP at 10 rpm at 0.8% w/W.

5. The CM-MFC from claim 1, wherein the CM-MFC comprises an ionic charge between 119-136 meq/100 g.

6. The CM-MFC from claim 1, wherein the CM-MFC is from BEKP CMC.

7. The CM-MFC from claim 1, wherein the CM-MFC is a BEKP CMC refined between 4-10%.

8. The CM-MFC from claim 1, wherein the CM-MFC comprises refining a CMC at a Gross specific energy between 450-580 kWh/t.

9. The CM-MFC from claim 1, wherein the viscosity is 35-44 cP @50 rpm; 0.85% w/w.

10. The CM-MFC from claim 1, wherein the transmittance is 45%-59% with a wavelength of 660 nm at 0.1% w/w.

11. The CM-MFC from claim 1, wherein the conductivity of 2.53-2.60 mS/cm at 1% w/w.

12. The CM-MFC from claim 12, wherein the originating cellulose has a crystallinity degree is 52%-62%.

13. The CM-MFC from claim 1, wherein the microfibrillated cellulose is obtained by a disc refining process.

14. The CM-MFC from claim 1, wherein the microfibrillated cellulose has a median diameter (d50) of less than 8 μm.

15. The CM-MFC from claim 1, having a diameter ranging from about 0.8 μm to 8 μm.

16. A method for producing a low viscosity CM-MFC, comprising steps of:
defibrating the resulting CMC with a rotating disc and a stationary rotor with a water dispersion of 4-10% w/w to obtain a CM-MFC at an extent that the CM-MFC fiber average diameter is between 0.8 μm to 8 μm.

17. The method according to claim 16, wherein the CM-MFC from claim 19, wherein the CM-MFC comprises a viscosity between 6700-9900 cP with a spindle R4 at 100 rpm at 6% w/w.

18. The method according to claim 19, wherein the CM-MFC has a degree of crystallinity of 38-49%.
